(19) United States
(12) Patent Application Publication
(10) Pub. No.: US 2020/0005100 A1
(43) Pub. Date: Jan. 2, 2020

(54) PHOTO IMAGE PROVIDING DEVICE AND PHOTO IMAGE PROVIDING METHOD

(71) Applicant: LG ELECTRONICS INC., Seoul (KR)

(72) Inventor: Sungsik KIM, Seoul (KR)

(73) Assignee: LG ELECTRONICS INC., Seoul (KR)

(21) Appl. No.: 16/565,935

(22) Filed: Sep. 10, 2019

(30) Foreign Application Priority Data
Aug. 22, 2019 (KR) 10-2019-0102802

(51) Int. Cl. G06K 9/66; G06K 9/52; G06K 9/62; G07C 9/00

(52) U.S. Cl. CPC G06K 9/66; G07C 9/00071; G06K 9/6217; G06K 9/522

(57) ABSTRACT

A photo image providing method includes learning an artificial neural network repeatedly to obtain user preference image quality information corresponding to a candidate photo image selected from a plurality of candidate photo images, and when obtaining a photo image from a camera, adjusting an image quality of the obtained photo image based on the obtained user preference image quality information.

### CROSS-REFERENCE TO RELATED APPLICATIONS

The present application claims priority under 35 U.S.C. 119 and 35 U.S.C. 365 to Korean Patent Application No. 10-2019-0102802 (filed on Aug. 22, 2019), which is hereby incorporated by reference in its entirety.

### BACKGROUND

The present disclosure relates to a photo image providing device and a photo image providing method that provide optimized image quality according to user preference.

Recently, as interest in photo images is explodingly increased due to the development of the Internet or social media, various devices that can provide photo images are being developed.

Photo images are taken in various shooting environments. For example, photo images are taken in various photographing environments such as a dark place, a misty place, a rainy cloudy day, a typhoon day, a snowy day, and a place where the sunset shines. In this case, the image quality of the captured photo image does not satisfy the user and is often discarded.

In particular, the user's preference image quality is very subjective, and the user's preference image quality is different. Therefore, a manufacturer of a device that can provide a photo image cannot provide image quality in consideration of the preferences of various users, but can only provide a universal image quality.

Since the desire to capture photo images reflecting the image quality of the user's preference is growing stronger, manufacturers are also urgently required to develop image quality according to a user preference.

### SUMMARY

The embodiment aims to solve the above and other problems.

Another object of the embodiment is to provide a photo image providing device and a photo image providing method that can provide optimized image quality according to user preference.

In one embodiment, a photo image providing method includes: learning an artificial neural network repeatedly to obtain user preference image quality information corresponding to a candidate photo image selected from a plurality of candidate photo images; and when obtaining a photo image from a camera, adjusting an image quality of the obtained photo image based on the obtained user preference image quality information.

In another embodiment, a photo image providing device includes: a camera; a memory configured to store artificial neural network; and a processor. The processor learns the artificial neural network repeatedly to obtain user preference image quality information corresponding to a candidate photo image selected from a plurality of candidate photo images; and when obtaining a photo image from the camera, adjusts an image quality of the obtained photo image based on the obtained user preference image quality information.

The additional scope of applicability of the embodiment will become apparent from the following detailed description. However, since various changes and modifications within the spirit and scope of the embodiment are be understood by those skilled in the art, it should be understood that the specific embodiments, such as the detailed description and the preferred embodiments, are given as examples only.

### BRIEF DESCRIPTION OF THE DRAWINGS

FIG. 1 illustrates an AI device 100 according to an embodiment of the present invention.

FIG. 2 illustrates an AI server 200 according to an embodiment of the present invention.

FIG. 3 illustrates an AI system 1 according to an embodiment of the present invention.

FIG. 4 is a block diagram illustrating a photo image providing device according to an embodiment of the present invention.

FIG. 5 is a flowchart illustrating a control method of a photo image providing device according to an embodiment of the present invention.

FIG. 6 is a flowchart illustrating a learning method according to user preference using candidate images in a photo image providing device according to an embodiment of the present invention.

FIG. 7 is a flowchart illustrating a learning method each time an image is acquired from a camera in a photo image providing device according to an embodiment of the present invention.

FIG. 8 shows first image quality information and second image quality information.

FIG. 9 illustrates a plurality of candidate images displayed on a display unit.

FIG. 10 shows linear regression learning.

### DETAILED DESCRIPTION OF THE EMBODIMENTS

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

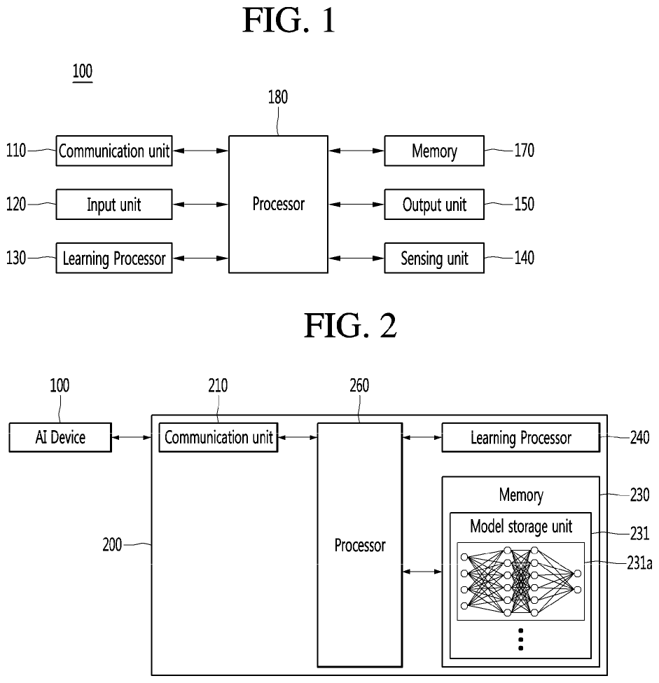

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

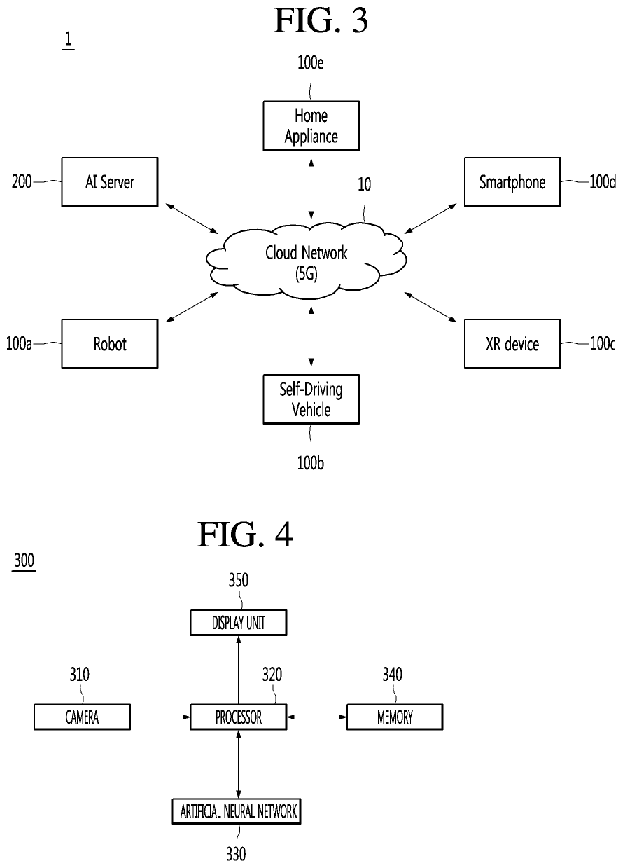

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

FIG. 4 is a block diagram illustrating a photo image providing device according to an embodiment of the present invention.

Referring to FIG. 4, a photo image providing device 300 according to an embodiment of the present invention may include a camera 310, a processor 320, an artificial neural network 330, a memory 340, and a display 350. Embodiments of the present invention may include more or fewer components than those described above.

The camera 310 may be included in the input unit 120 shown in FIG. 1. Each of the processor 320 and the memory 340 may be the processor 180 and the memory 170 shown in FIG. 1. The display unit 350 may be included in the output unit 150 shown in FIG. 1. The processor 320 may include an image signal processing (ISP) block.

The photo image providing device 300 may include, for example, a mobile terminal, a wearable device, a drone, or the like. The mobile terminal may include a smart phone, a mobile phone, a tablet device, a game device, and the like. The wearable device may include a smartwatch, smart glass, or the like.

The camera 310 may take a photo image.

The processor 320 may manage or control the above-described components as a whole. For example, the processor 320 may control the camera 310 to capture a photo image. For example, the processor 320 may control the display unit 350 to display content, information, or data. For example, the processor 320 may control the memory 340 to store content, information, data, and newly generated information.

The artificial neural network 330 may be composed of software or hardware. The artificial neural network 330 configured as software may be stored in the memory 340. The artificial neural network 330 stored in the memory 340 may be operated under the control of the controller.

The artificial neural network 330 may learn to obtain user preference image quality information corresponding to a candidate photo image selected among the plurality of candidate photo images of each of the plurality of photographic environment information.

The photographic environment information may include one of the low illumination scene, food scene, portrait scene, landscape scene, or backlight scene.

The processor 320 may obtain a plurality of candidate photo images based on the plurality of first image quality information and the plurality of second image quality information for each of the plurality of first image quality information. That is, each of the plurality of second image quality information for each of the plurality of first image quality information is reflected in the obtained photo image, so that a plurality of candidate photo images may be obtained. That is, by adjusting the image quality of the photo image with each of the plurality of second image quality information for each of the plurality of first image quality information, a plurality of candidate photo images may be obtained.

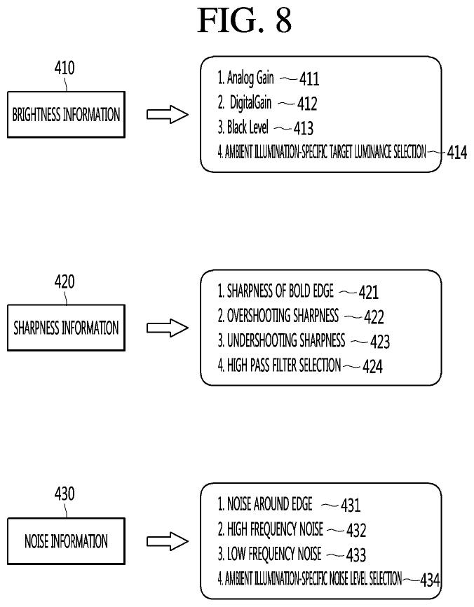

For example, as shown in FIG. 8, when the photographic environment information has a low illumination scene, the first image quality information may include, for example, brightness information 410, sharpness information 420, noise information 430, and the like.

The second image quality information may be detailed information of the first image quality information.

For example, when the first image quality information is the brightness information 410, the second image quality information may include an analog gain 411, a digital gain 412, a black level 413, a target luminance for each ambient illumination 414, and the like.

For example, when the first image quality information is the sharpness information 420, the second image quality information may include a sharpness of a thick edge 421, an overshooting sharpness 422, an undershooting sharpness 423, a high pass filter selection 424, and the like.

For example, when the first image quality information is the noise information 430, the second image quality information may include a noise around the edge 431, a high frequency noise 432, a low frequency noise 433, and a noise level selection for each ambient illumination 434, and the like

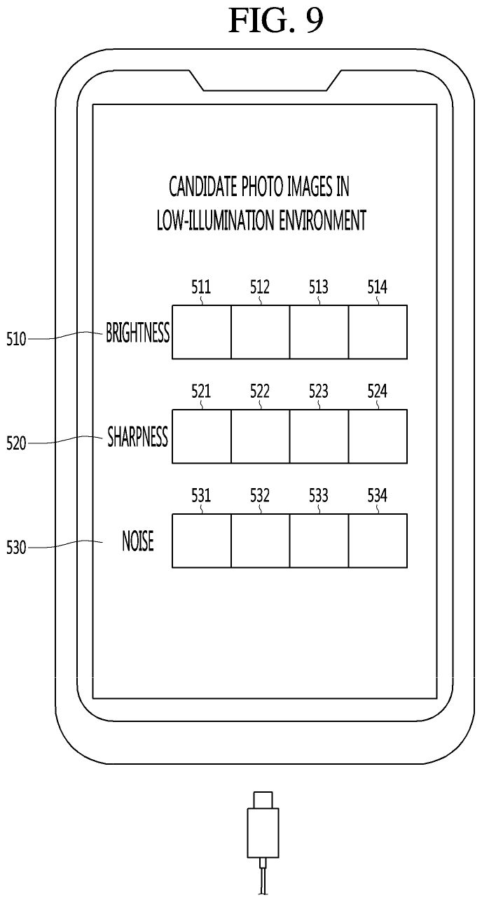

For example, as shown in FIG. 8, the processor 320 may generate four candidate photo images 511 to 514 (see FIG. 9) for each of the analog gain 411, the digital gain 412, the black level 413, and the target luminance for each ambient illumination 414, which are detailed information of the brightness information 410 at the low illumination scene,

For example, as shown in FIG. 8, the processor 320 may generate four candidate photo images 521 to 524 (see FIG. 9) for each of a sharpness of a bold edge 421, an overshooting sharpness 422, an undershooting sharpness 423, and a high pass filter selection 424, which are detailed information of sharpness information 420 at the low illumination scene.

For example, as shown in FIG. 8, the processor 320 may generate four candidate photo images 531 to 534 (see FIG. 9) for each of a noise around an edge 431, a high frequency noise 432, a low frequency noise 433, and a noise level selection for each ambient illumination 434, which are detailed information of the noise information 430 at the low illumination scene.

Thus, the processor 320 may generate, for example, 12 candidate photo images 511 to 514, 521 to 524, and 531 to 534 (see FIG. 8) at the low illumination scene.

Meanwhile, the processor 320 may generate candidate photo images for the lower limit and the upper limit of each of the detailed information 411 to 414, 421 to 424, and 431 to 434 illustrated in FIG. 8.

The detailed information 411 to 414, 421 to 424, and 431 to 434 shown in FIG. 8 may be a default value. For example, when the analog gain 411 shown in FIG. 8 is 50, the lower limit may be 20 and the upper limit may be 100. Accordingly, three candidate photo images for the default, the lower limit, and the upper limit may be generated for the analog gain 411 which is detailed image quality information of the brightness information 410 of the low illumination scene. Accordingly, the processor 320 may generate candidate photo images for each of the default, lower limit, and upper limit of the detailed information 411 to 414, 421 to 424, and 431 to 434 shown in FIG. 8, there by generating a total of 36 candidate photo images.

In FIG. 8, only the brightness information 410, the sharpness information 420, and the noise information 430 are shown in the low illumination scene for convenience of description but other image quality information that affects the image quality may be further added.

For example, in low illumination scenes, brightness, sharpness, and noise can have a significant impact on image quality. For example, in food scenes, white balance can have a significant impact on image quality. In portrait scenes, sharpness and noise can have a significant impact on image quality. In landscape scenes, hue, saturation, and white balance can have a significant impact on image quality. In back light scenes, exposure can have a significant impact on image quality.

Accordingly, according to the plurality of photographic environment information, the processor 320 may display a plurality of candidate photo images corresponding thereto on the display unit 350.

In the above description, the two image quality information, that is, the first image quality information 410, 420, and 430 and the second image quality information 411 to 414, 421 to 424, and 431 to 434, are described but three or more image quality information may be considered. For example, the first image quality information, the second image quality information which is detailed information of the first image quality information, the third image quality information which is detailed information of the second image quality information, and the fourth image which is detailed information of the third image quality information may be considered. In such a way, as the number of detailed information increases, it is possible to more accurately grasp the user's preference.

The processor 320 may control the display 350 to display a plurality of candidate photo images. As illustrated in FIG. 9, a plurality of candidate photo images 511 to 514, 521 to 524, and 531 to 534 may be displayed on the display 350.

The plurality of candidate photo images 511 to 514, 521 to 524, and 531 to 534 displayed on the display unit 350 of FIG. 9 may be, for example, photo images for low illumination scenes, but are not limited thereto. The plurality of candidate photo images 511 to 514, 521 to 524, and 531 to 534 may be thumbnail images, but are not limited thereto.

For example, candidate photo images 511 to 514, 521 to 524, and 531 to 534 may be displayed in line for each of the brightness image 510, the sharpness image 520, and the noise image 530 for the low illumination scene. For example, the candidate photo images 511 to 514 for the brightness image 510 may be displayed on the display 350 for the low illumination scene. After the displayed candidate photo images 511 to 514 disappear, the candidate photo images 521 to 524 for the sharpness image 520 may be displayed. After the displayed candidate photo images 521 to 524 disappear, the candidate photo images 531 to 534 for the noise image 530 may be displayed.

On the display 350 of FIG. 9, for convenience of explanation, as shown in FIG. 8, 12 candidate photo images 511 to 514, 521 to 524, and 531 to 534 that are set as defaults are displayed, but candidate photo images for each of the lower limit and the upper limit may be further displayed.

The processor 320 may acquire a candidate photo image selected from a plurality of candidate photo images. The selected candidate photo image may be stored in the memory 340. The selected candidate photo image may be provided to the artificial neural network 330. That is, the selected candidate photo image may be used as input data for learning the artificial neural network 330.

The artificial neural network 330 may acquire user preference image quality information by learning the selected candidate photo image.

Each time a photo image is acquired from the camera 310, the processor 320 may display the plurality of candidate photo images on the display 350 and acquire a candidate photo image selected from the plurality of candidate photo images. In such a way, whenever a photo image is acquired from the camera 310, by learning the candidate photo image selected by the user to obtain user preference image quality information, it is possible to obtain user preference more accurately. The user preference image quality information may be a parameter value for a photo image in specific photographic environment information.

When acquiring a photo image from the camera 310, the processor 320 may adjust the image quality of the obtained photo image based on the obtained user preference image quality information. For example, user preference image quality information obtained by repeatedly learning by the artificial neural network 330 in the low illumination scene may be shown in Table 1. In Table 1, it should be noted that the numerical value of the user preference image quality information is not a value actually obtained but is arbitrarily given for convenience of description.

TABLE 1

| | | | User preference |
|---|---|---|---|
| | First image | Second image | image quality |
| | quality information | quality information | information |
| Low | Brightness | Digital gain | 28 |
| illumination | information (410) | (412) | |
| scene | Sharpness | Overshooting | 43 |
| | information (420) | sharpness (422) | |
| | Noise | noise around | 12 |
| | information (430) | edge (431) | |

The processor 320 may adjust the photo image obtained from the camera 310 with the user image quality information shown in Table 1. For example, if the obtained photo image is a low illumination photo image, based on user preference image quality information, the processor adjusts brightness to a digital gain of 28, sharpness to an overshooting sharpness of 43, and noise to an edge ambient noise of 12. In such a way, the photo image whose image quality is adjusted may be stored in the memory 340 and displayed on the display unit 350 at the user's request.

Each time a photo image is acquired from the camera 310, the artificial neural network 330 acquires user preference image quality information by learning a candidate photo image selected by the user such that it is possible to provide a photo image of image quality corresponding to the user's preference.

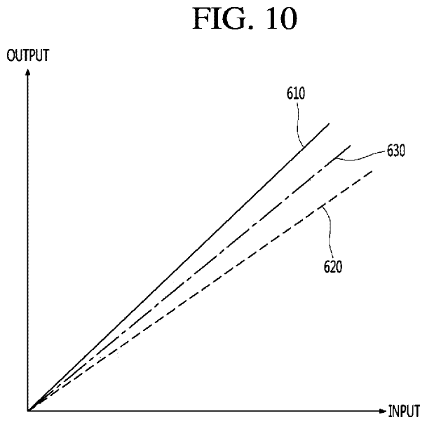

FIG. 10 shows linear regression learning.

In FIG. 10, the horizontal axis may be, for example, a candidate photo image selected by a user as an input of the artificial neural network 330, and the vertical axis may be, for example, user preference image quality information as an output of the artificial neural network 330. Linear regression may be a regression analysis model that models the linear correlation between a dependent variable y and an independent variable x. There may be more than one independent variable x. Linear regression uses linear prediction functions to model regressions, unknown parameters are estimated from data, and the resulting regressions are called linear models.

In an embodiment of the present invention, the independent variable x may be a candidate photo image selected by the user, and the dependent variable y may be user preference image quality information.

From FIG. 10, a linear correlation between a user selected candidate photo image (independent variable x) and user preference image quality information (dependent variable y) may be modeled.

When the user's most preferred line is the target line, that is, the base line 610, by repeatedly learning only the artificial network, the first estimation line 620 may be generated as shown in FIG. 10.

Again, by iteratively learning the artificial neural network 330 to be closer to the base line 610, the second estimation line 620 may be generated. The second estimation line 620 may be generated closer to the base line 610 than the first estimation line 620. Accordingly, the artificial neural network 330 may obtain user preference image quality information based on the second estimation line 620, and the obtained user preference image quality information may be even closer to the user's preference. The first estimation line 620, the second estimation line 620, and the base line 610 may have linear lines, but are not limited thereto.

Ultimately, the artificial neural network 330 may continuously adjust the estimation line to approach the base line 610, thereby obtaining optimal user preference image quality information.

According to an embodiment of the present invention, it is possible to obtain optimal user preference image quality information by repeatedly learning the artificial neural network 330 to obtain user preference image quality information corresponding to a candidate photo image selected among the candidate photo images of each of the plurality of photographic environment information. By adjusting the image quality of the photo image obtained from the camera 310 based on the optimal user preference image quality information obtained in such a way, the user's satisfaction can be improved by providing a photo image considering the user's preference.

In the following, the photo image providing method is described in more detail.

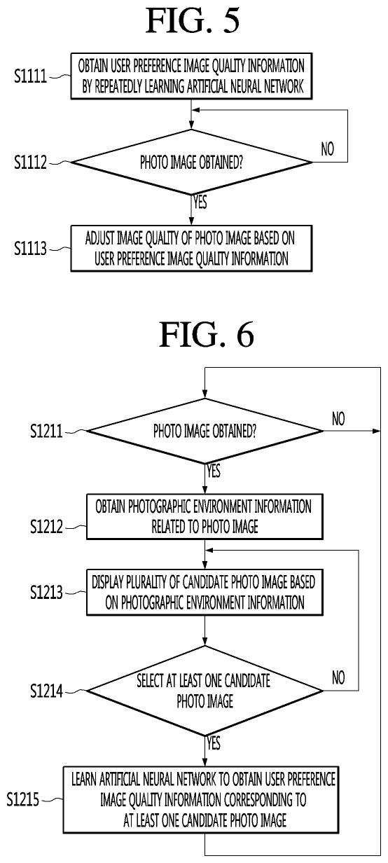

FIG. 5 is a flowchart illustrating a control method of a photo image providing device according to an embodiment of the present invention.

Referring to FIGS. 4 and 5, the processor 320 may repeatedly learn the artificial neural network 330 to obtain user preference image quality information (S1111).

Each time a photo image is acquired from the camera 310, the processor 320 may repeatedly learn the artificial neural network 330.

When the photo image is acquired (S1112), the processor 320 may adjust the image quality of the obtained photo image based on user preference image quality information (S1113).

Referring to FIG. 6, such an image quality adjusting method will be described in more detail. FIG. 6 is a flowchart illustrating a learning method according to user preference using candidate images in a photo image providing device according to an embodiment of the present invention.

As shown in FIG. 6, when a photo image is acquired (S1211), the processor 320 may obtain photographic environment information related to the obtained photo image (S1212).

The photographic environment information may include at least one of the low light scene, food scene, portrait scene, landscape scene, or backlight scene. For example, when a photo image is acquired in a dark place the processor 320 may obtain photographic environment information, which is a low illumination scene. For example, when the photo image is food, the processor 320 may obtain photographic environment information, which is a food scene.

The processor 320 may control to display the plurality of candidate photo images on the display 350 based on the obtained photographic environment information (S1213).

For example, when the photo image acquired from the camera 310 is a low illumination scene, a plurality of candidate photo images may be obtained using image quality information in the low illumination scene. The processor 320 may display the obtained plurality of candidate photo images on the display unit 350. Since a method of acquiring a plurality of candidate photo images based on the first image quality information and the second image quality information illustrated in FIG. 8 has been described, the detailed description thereof will be omitted.

When receiving at least one candidate photo image selected from a plurality of candidate photo images (S1214), the processor 320 may learn the artificial neural network 330 to obtain user preference image quality information corresponding to the selected at least one candidate photo image (S1215). The candidate photo image may be selected for each of the first image quality information, for example, the brightness information 410, the sharpness information 420, and the noise information 430 illustrated in FIG. 8, but is not limited thereto.

In FIG. 6, one-time learning of the artificial neural network 330 is described.

The processor 320 may repeatedly acquire the optimal user preference image quality information by repeatedly performing the learning process as shown in FIG. 6.

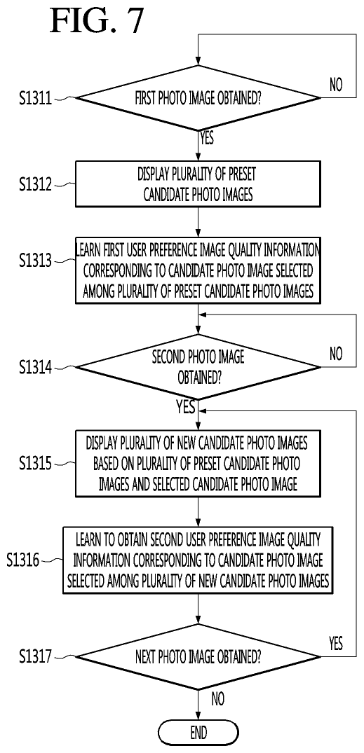

This repetitive learning is described with reference to FIG. 7. FIG. 7 is a flowchart illustrating a learning method each time an image is acquired from a camera in a photo image providing device according to an embodiment of the present invention.

Referring to FIGS. 4, 5, and 7, when the first photo image is acquired from the camera 310 (S1311), the processor 320 may control to display a plurality of preset candidate photo images on the display unit 350 (S1312).

The plurality of preset candidate photo images may be obtained from at least one of a manufacturer, a content provider, an SNS, and the Internet. For example, the plurality of preset candidate photo images may be universal image quality information set through trial and error by a developer of a manufacturer. For example, as shown in FIG. 8, it may be detailed information set as a default for each of brightness information 410, sharpness information 420, and noise information 430 in a low illumination scene. For example, the plurality of preset candidate photo images may be image quality information universally applied to photo images collected on SNS. For example, the plurality of preset candidate photo images may be image quality information universally applied to photo images roaming on the Internet.

The processor 320 may learn the artificial neural network 330 to obtain first user preference image quality information corresponding to a candidate photo image selected among a plurality of preset candidate photo images (S1313).

If a second photo image is acquired from the camera 310 (S1314), the processor 320 may control to display the plurality of new candidate photo images on the display unit 350 based on the plurality of preset candidate photo images and the selected candidate photo image (S1315).

It can be obtained based on the value of the second image quality information determined between a value of the second image quality information of the preset candidate photo image and a value of the second image quality information of the selected candidate photo image. For example, it is assumed that the digital gain 412 is preset to 10 (default), 5 (lower limit), and 20 (upper limit) for the brightness information 410 in low illumination scenes and the user selects 20 (upper limit) of the digital gain 412. In such a case, in relation to a new candidate photo image, the digital gain value may be determined between 10 (default) and 20 (upper limit). For example, a new candidate photo image may be obtained based on the digital gain 412 of 17.

The plurality of new candidate photo images may be smaller than the number of plurality of preset candidate photo images.

The processor 320 may learn the artificial neural network 330 to obtain second user preference image quality information corresponding to a candidate photo image selected among a plurality of new candidate photo images (S1316).

When the next photo image is acquired from the camera 310 (S1317), the processor 320 may learn the artificial neural network 330 to obtain third user preference image quality information through the same process as S1315 and S1316. That is, when the next photo image is acquired (S1317), the processor 320 may obtain a plurality of new candidate photo images based on the plurality of preset candidate photo images and the selected candidate photo image, and learn an artificial neural network to obtain third user preference image quality information corresponding to the plurality of new candidate photo images.

For example, since the new candidate photo image is acquired based on the digital gain 412 of 17 in S1315, a digital gain 412 may be determined between 17 and 20 (upper limit) of a new candidate photo image inputted to the artificial neural network 330 to obtain third user preference image quality information. For example, a new candidate photo image may be obtained based on the digital gain 412 of 19. The processor 320 may acquire new user preference image quality information by learning a new candidate photo image acquired based on the digital gain 412 of 19.

Therefore, by repeatedly performing S1315 and S1316, as the range of the second image quality in the new candidate photo image, that is, the gap between the previously set value and the newly set value, is decreased, the estimation line is close to the base line 610 so that this may mean that the possibility of obtaining optimal user preference image quality information becomes high.

The effects of the photo image providing device and the photo image providing method according to the embodiment will be described below.

According to at least one of the embodiments, by repeatedly learning artificial neural networks to obtain user preference image quality information corresponding to a candidate photo image selected among the candidate photo images of each of the plurality of photographic environment information, the optimal user preference image quality information can be obtained. In addition, by adjusting the image quality of the photo image obtained from the camera based on the optimal user preference image quality information obtained in this way, the user's satisfaction can be improved by providing a photo image considering the user's preference.

The foregoing detailed description is to be regarded as illustrative and not restrictive. The scope of the embodiment should be determined by reasonable interpretation of the appended claims, and all modifications within equivalent ranges of the embodiment are included in the scope of the embodiment.

What is claimed is:

1. A photo image providing method comprising:
learning an artificial neural network repeatedly to obtain user preference image quality information corresponding to a candidate photo image selected from a plurality of candidate photo images; and
when obtaining a photo image from a camera, adjusting an image quality of the obtained photo image based on the obtained user preference image quality information.

2. The method of claim 1, wherein the learning of the artificial neural network repeatedly comprises:
obtaining photographic environment information related to the obtained photo image from among a plurality of photographic environment information when obtaining a photo image from the camera;
controlling to display a plurality of candidate photo images based on the obtained photographic environment information; and
learning the artificial neural network to obtain user preference image quality information corresponding to at least one candidate photo image selected from the plurality of candidate photo images.

3. The method of claim 1, further comprising:
when a first photo image is obtained from the camera, controlling to display a plurality of candidate photo images, the plurality of candidate photo images being preset as a plurality of candidate photo images of photographic environment information related to the first photo image;
learning to obtain first user preference image quality information corresponding to a candidate photo image selected from the plurality of preset candidate photo images;
when a second photo image is obtained from the camera, controlling to display a plurality of new candidate photo images based on the plurality of preset candidate photo images and the selected candidate photo image, as a plurality of candidate photo images of photographic environment information related to the second photo image; and
learning to obtain second user preference image quality information corresponding to a candidate photo image selected from the plurality of new candidate photo images.

4. The method of claim 3, wherein the first user preference image quality information is obtained based on a first estimation line,
wherein the second user preference image quality information is obtained based on a second estimation line,
wherein the second estimation line is closer to a base line than the first estimation line.

5. The method of claim 3, wherein the plurality of preset candidate photo images are obtained from at least one of a manufacturer, a content provider, an SNS, or the Internet.

6. The method of claim 1, wherein the photographic environment information comprises at least one of a low illumination scene, a food scene, a portrait scene, a landscape scene, or a backlight scene.

7. The method of claim 1, further comprising obtaining the plurality of candidate photo images based on a plurality of first image quality information and a plurality of second image quality information for each of the plurality of first image quality information.

8. The method of claim 7, wherein the first image quality information comprises at least one of brightness, sharpness, noise, white balance, hue, or saturation, and
the second quality information comprises detailed image quality information of the first image quality information.

9. The method of claim 1, wherein the artificial neural network performs linear regression learning.

10. The method of claim 1, wherein the user preference image quality information is a parameter value for a photo image in each of the plurality of photographic environment information.

11. A photo image providing device comprising:
a camera;
a memory configured to store artificial neural network; and
a processor,
wherein the processor
learns the artificial neural network repeatedly to obtain user preference image quality information corresponding to a candidate photo image selected from a plurality of candidate photo images; and
when obtaining a photo image from the camera, adjusts an image quality of the obtained photo image based on the obtained user preference image quality information.

12. The photo image providing device of claim 11, wherein the processor
obtains photographic environment information related to the obtained photo image from among a plurality of photographic environment information when obtaining a photo image from the camera,
controls to display a plurality of candidate photo images based on the obtained photographic environment information, and
learns the artificial neural network to obtain user preference image quality information corresponding to at least one candidate photo image selected from the plurality of candidate photo images.

13. The photo image providing device of claim 11, wherein the processor
when a first photo image is obtained from the camera, controls to display a plurality of candidate photo images, the plurality of candidate photo images being preset as a plurality of candidate photo images of photographic environment information related to the first photo image;
learns to obtain first user preference image quality information corresponding to a candidate photo image selected from the plurality of preset candidate photo images;
when a second photo image is obtained from the camera, controls to display a plurality of new candidate photo images based on the plurality of preset candidate photo images and the selected candidate photo image, as a plurality of candidate photo images of photographic environment information related to the second photo image; and
learns to obtain second user preference image quality information corresponding to a candidate photo image selected from the plurality of new candidate photo images.

14. The photo image providing device of claim 13, wherein the first user preference image quality information is obtained based on a first estimation line,
wherein the second user preference image quality information is obtained based on a second estimation line,
wherein the second estimation line is closer to a base line than the first estimation line.

15. The photo image providing device of claim 13, wherein the plurality of preset candidate photo images are obtained from at least one of a manufacturer, a content provider, an SNS, or the Internet.

16. The photo image providing device of claim 11, wherein the photographic environment information comprises at least one of a low illumination scene, a food scene, a portrait scene, a landscape scene, or a backlight scene.

17. The photo image providing device of claim 11, wherein the processor further obtains the plurality of candidate photo images based on a plurality of first image quality information and a plurality of second image quality information for each of the plurality of first image quality information.

18. The photo image providing device of claim 17, wherein the first image quality information comprises at least one of brightness, sharpness, noise, white balance, hue, or saturation, and
the second quality information comprises detailed image quality information of the first image quality information.

19. The photo image providing device of claim 11, wherein the artificial neural network performs linear regression learning.

20. The photo image providing device of claim 11, wherein the user preference image quality information is a parameter value for a photo image in each of the plurality of photographic environment information.
